(19) United States
(12) Patent Application Publication
(10) Pub. No.: US 2014/0001224 A1
(43) Pub. Date: Jan. 2, 2014

(54) CORDLESS FASTENING TOOL CONTROL SYSTEM

(71) Applicant: BLACK & DECKER INC., Newark, DE (US)

(72) Inventors: Brian McNeill, Warwick, RI (US); Gianpaolo Scabin, Lissone (MB) (IT); David Ross, Orange, CT (US)

(73) Assignee: BLACK & DECKER INC., Newark, DE (US)

(21) Appl. No.: 13/839,177

(22) Filed: Mar. 15, 2013

Related U.S. Application Data
(60) Provisional application No. 61/665,645, filed on Jun. 28, 2012.

(51) Int. Cl. B25C 5/15

(52) U.S. Cl. CPC B25C 5/15
USPC 227/1

(57) ABSTRACT

A power tool is provided including a housing; a driver configured to move downward during a drive stroke and upward during a return stroke; an electric motor configured to drive the driver; and a control unit. The control unit is configured to control a supply of power form a power source to the motor and brake the motor upon or within a predetermined time after the driver reaches approximately its uppermost upward position to stop the motor prior to the completion of the return stroke.

### CROSS-REFERENCE TO RELATED APPLICATIONS

This application claims the benefit of U.S. Provisional Patent Application Ser. No. 61/665,645 filed Jun. 28, 1012. This application also claims the benefit of priority from U.S. Provisional Patent Application Ser. No. 61/665,516, filed Jun. 28, 2012, and United States Provisional Patent Application Ser. No. 61/772,105, filed Mar. 4, 2013, the entire contents of both of which are incorporated herein by reference.

### FIELD

This invention relates to fastener driving devices and more particularly to a control circuit for cordless fastener driving tools of the type including clinching mechanisms for securing cartons in a closed manner.

### BACKGROUND

Power operated fastener driving tools are traditionally used in industrial applications where compressed air provides a convenient power source. Because of the nature of the compressed air power source and the expense involved in heavy duty industrial fastener driving tools, such tools are generally not suitable for use in fastening jobs where maneuvering is required, space is limited, or compressed air is not available. Manually operated fastener driving tools are also used in industrial applications. However, in many of the jobs where manually operated fastener driving tools are used, considerable operator fatigue may be involved because a manual fastener driving tool requires a large user actuation force.

One solution is to use electric motors to drive the fastening device. What is needed is effective and suitable control mechanism to utilize for a fastener driving tool.

### SUMMARY

According to an embodiment of the invention, a power tool is provided including a housing; a driver configured to move downward during a drive stroke and upward during a return stroke; an electric motor configured to drive the driver; and a control unit. The control unit is configured to control a supply of power form a power source to the motor and brake the motor upon or within a predetermined time after the driver reaches approximately its uppermost upward position to stop the motor prior to the completion of the return stroke. According to an embodiment, the driver is configured to drive a fastener into a workpiece during the drive stroke.

According to an embodiment of the invention, a sensor is arranged to detect a position of a moving component associated with the driver. In an embodiment, the sensor is a Hall Effect sensor, and a sense magnet is provided inside or in association with the moving component. The sense magnet is sensable by the Hall Effect sensor when the moving component reaches a predetermined position. In another embodiment, the sensor is a switch that is mechanically actuated when the moving component reaches a predetermined position.

In an embodiment, the sensor is configured to provide a position signal to the control unit when the moving component reaches a predetermined position, and the control unit is configured to brake the motor upon receiving the position signal from the sensor. In another embodiment, the sensor provides a variable voltage to the control unit indicative of the position the moving component and the control unit is configured to brake the motor when the variable voltage exceeds a predetermined threshold.

According to an embodiment, the power tool further includes: a crank arm connected to the motor; and a connecting rod pivotably coupled to the driver at one end portion thereof and pivotably connected to the crank arm at an opposite end portion thereof, the connecting rod being configured to pull the driver downward through the drive stroke when the crank arm rotates with the motor. The moving component may be one of the connecting rod or the driver, in which case the sensor is arranged to detect a predetermined axial position of the moving component. Alternatively, the moving component may be the crank arm, in which case the sensor is arranged to detect a predetermined angular position of the moving component. In a yet further embodiment, the moving component is a mount connecting the driver to the connecting rod, and the sensor is arranged to detect a predetermined axial position of the moving component.

In an embodiment, the motor comprises a positive terminal and a negative terminal, and the control unit is configured to brake the motor by activating a switch to short the positive and negative terminals of the motor. In an embodiment, the control unit is configured to stop supply power to the motor at a predetermined time before it brakes the motor. In an embodiment, the tool includes an input switch actuated by a user, and the control unit is configured to supply power to drive the motor when the input switch is actuated by the user.

### DESCRIPTION OF THE DRAWINGS

The numerous advantages of the present invention may be better understood by those skilled in the art by reference to the accompanying figures. In the drawings, like reference numerals designate corresponding parts throughout the several views.

FIG. 1 illustrates a cross-sectional view of an exemplary fastener driving tool constructed in accordance with embodiments of the invention;

FIG. 2 illustrates a fastener clinching assembly of the tool of FIG. 1 in an upward and open position;

FIG. 3 illustrates the fastener clinching assembly of FIG. 2 at the beginning of actuation;

FIG. 4 illustrates the fastener clinching assembly of FIG. 2 in a downward and closed position;

FIG. 5 depicts a circuit diagram of the control system for the fastener driving tool, according to an embodiment.

The drawings described herein are for illustrative purposes only of selected embodiments and not all possible implementations, and are not intended to limit the scope of the present disclosure. Corresponding reference numerals indicate corresponding parts throughout the several views of the drawings.

### DESCRIPTION

Reference will now be made in detail to the present embodiments of the invention, examples of which are illustrated in the accompanying drawings.

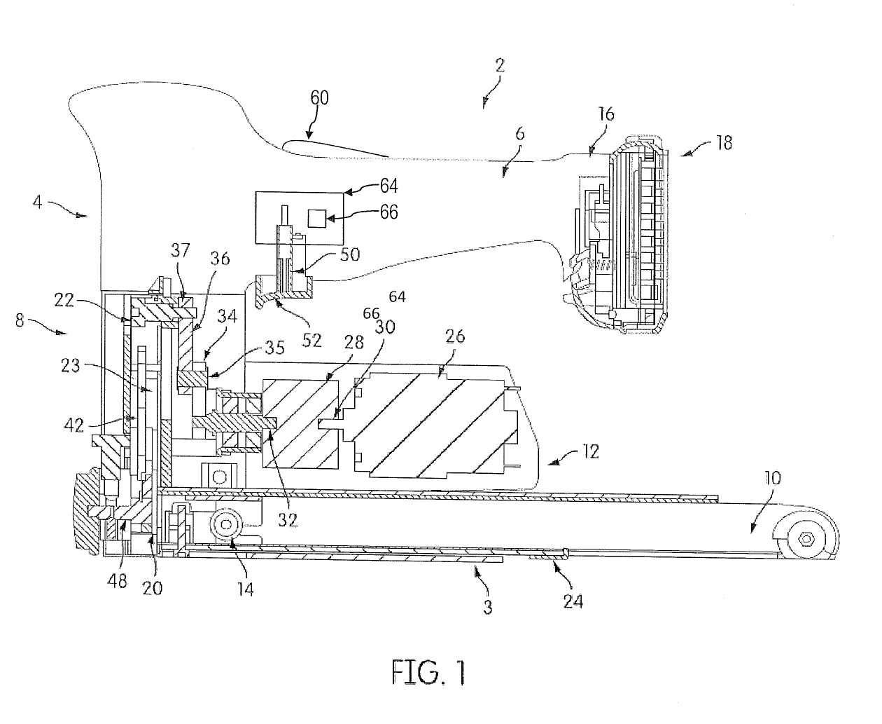

Referring now more particularly to the drawings, there is shown in FIG. 1, a cross-sectional side view of a fastener driving tool, generally indicated at 2, which embodies the principles of the present invention. As shown, the tool is an electrically actuated portable-type tool capable of driving staples and clinching the same into workpieces, such as carton flaps and the like. The staples can be carried as a supply within the tool in the form of elongated preformed or non-preformed staples interconnected together in parallel relation and arranged linearly within a magazine or in a coil form in a coil magazine.

As shown in FIG. 1, the tool 2 includes a housing section, generally indicated at 4, which provides a handle portion 6 adapted to be gripped by the hand of a user, and a vertical section 8 extending forwardly and downwardly from the forward end of the handle 6. The tool includes a tool base 3 that contacts a surface of a workpiece W during use. A magazine 10 is connected to the nose portion of the tool and a motor-transmission unit 12 is disposed between the magazine 10 and the handle 6. The housing section 4 can be integral with the motor-transmission unit 12 and formed in a single casting. Alternatively, the housing section 4 and the motor-transmission unit 12 can be separately cast and the motor-transmission unit mounted onto the housing section 4. The magazine 10 is provided for storing and arranging staples for delivery to a fastener driving assembly. The magazine 10 can be an elongated member as shown in FIG. 1 in which staples are arranged linearly in parallel. Alternatively, the staples can be arranged in a coil for a more compact tool. The magazine includes a pusher 14 for pushing staples from an insertion end of the tool to a delivery end of the tool where the staples can be driven by a driver 23, which may be in the form of a driver blade, of the driving assembly and embedded into the workpiece W. The magazine also includes a magazine release lever 24 to disconnect the magazine 10 from the tool 2 when a staple is jammed in the tool.

In an embodiment, the handle 6 extends from the housing section 4 to a handle end portion 16 having a battery pack 18. The battery pack 18 is configured to engage the handle end portion 16 and provide power to a motor 26 in the motor transmission unit 12 such that the tool 2 can drive one or more nails which are fed from the magazine 10. Although the battery pack 18 is illustrated as being connected to the handle end portion 16, the battery pack 18 can be located anywhere on the tool 2.

Provided in the vertical section 8 of the housing section 4 is the driver 23 of the fastener driving assembly. A driver mounting block, i.e. mount 22 is located in a drive channel and moves through successive operating cycles, each of which includes a downward drive stroke and an upward return stroke. The mount 22 has connected thereto, the driver 23. Actuation of the driver 23 drives staples, which are sequentially fed from the magazine 10 to a drive track 20 within the housing 4, into a clincher assembly 40, which may also be referred to herein as a clincher, then into the workpiece W. As shown, the driver 23 is connected to the upper end of the mount 22 and is forced to follow the linear motion of the mount. In an embodiment, the mount is integral with the driver.

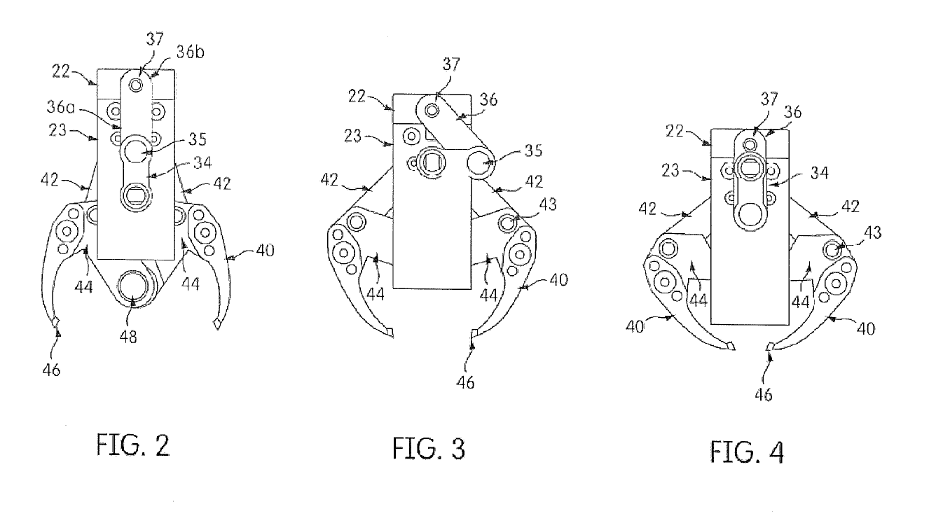

As shown in FIGS. 1-4, and particularly in FIGS. 2-4, a connecting rod 36 is pivotably connected at a lower end 36a thereof through a lower pivot pin 35 to a crank arm 34, which is connected to a crankshaft 32. The connecting rod 36 is pivotably connected at an upper end 36b to the mount 22 through an upper pivot pin 37. The connecting rod 36 pivots outwardly from the center line of the mount 22 as the crank arm 34 moves the lower end 36a of the connecting rod 36. The connecting rod 36 pulls the mount 22 downward toward the nose through the drive stroke. Therefore, as the crank arm 34 rotates, the connecting rod 36 acts as a linear actuator by converting the rotational motion of the crank arm 24 into linear motion of the mount 22 through a drive stroke in the drive track 20. One complete 360-degree rotation of the crankshaft 32 and therefore the crank arm 34 is equivalent to one complete downward and upward cycle of the mount 22.

The clincher assembly 40, which is shown in more detail in FIGS. 2-4, is mounted proximal to the nose of the tool 2 in a position to define the lower portion of the drive track 20. The clincher assembly 40 includes a pair of clincher linkages 42, a pair of clincher arms 44, and a pair of clincher anvils 46. During the down stroke of the mount 22, the driver 23 drives a staple into the workpiece W. The closing of the staple within the carton is achieved by the clincher assembly 40. Upper ends of the clincher linkages 42 are pivotably connected to the mount 22 such that the downward movement or downstroke of the mount 22 moves the clincher linkages 42 downward. A lower end of each clincher linkage 42 is connected to a respective clincher arm 44. The downward motion of the mount 22 causes the clincher arms 44 to rotate about a pivot pin 48. The upstroke of mount 22 returns the driver 23 and the clincher arms 44 to the home or at-rest positions.

As shown in FIG. 2, the clincher assembly 40 is shown in a retracted state. The clincher arms 44 are pivoted to the lower end of the housing section 4 by the pivot pin 48 and are further pivotable on the clincher linkage 42 by pivot members 43. Each clincher arm 44 has mounted on the outer end thereof an arcuate clincher anvil 46 which, when the clincher assembly 40 is disposed in its retracted position, as shown in FIG. 2, extends arcuately downwardly from the end of the associated clincher arm 44. In order to accomplish the clinching action, the clincher anvils 46 are moved downwardly and inwardly along an arcuate path into a clinching position. This movement is accomplished in response to the downward movement of the mount 22 by means of the connecting rod 36 being pivoted at its upper end through the upper pivot pin 37, and at its lower end to the crank arm 34.

The clincher assembly 40, crank arm 34 and crankshaft 32 are actuated by a manual actuating mechanism or trigger assembly, generally indicated at 50, shown in FIG. 1, which is operable to activate the motor 26. As best shown in the Figure, the trigger assembly 50 includes a trigger member 52 which is adapted to be digitally engaged by a user grasping the housing handle portion 6.

The motor 26 is actuated by the trigger assembly 50. The trigger assembly 50 is mechanically coupled to handle 6 and electrically coupled to motor 26 such that the trigger assembly selectively provides electric power to motor assembly. The motor 26 includes a rotatable output shaft 30 that extends into the gear reduction mechanism 28, which reduces the rotational speed of the output shaft 30 and causes rotation of the crankshaft 32 at the reduced rotational speed.

The electric motor 26 provides a power source to the tool 2 to operate the clincher assembly 40 as shown in FIGS. 2-4. In FIG. 2, the tool 2 is in a resting state. The mount 22 is in a top position before the actuating mechanism or trigger member 52 is engaged. In this state, the clincher anvils 46 are open. The leading staple S is in the magazine and connected to the remaining stick of staples.

With the tool 2 provided with a staple supply in the manner indicated above, the staples being formed in a U-shaped or flat configuration; and with the leading staple S disposed within the drive track 20, it will be understood that when the user actuates the trigger member 52, the connecting rod 36 will be moved through a drive stroke carrying with it the mount 22, and the clincher assembly 40.

Referring now more particularly to FIGS. 3 and 4, the construction and operation of the clincher assembly 40 of the embodiments of the present invention is shown therein.

FIG. 3 illustrates the initial actuation of the tool when the trigger 52 is actuated, which causes the mount 22 to move through the drive stroke. During the initial portion of the drive stroke, the lower end of the driver 23 engages the crown C of the staple within the drive track 20 and moves the same downwardly. In addition, the clincher assembly 40 is operated so that the clincher anvils 46 thereof are moved into a position to receive the free ends of the legs L of the staple being driven as the latter move outwardly of the lower end of the drive track and into the workpiece. The clincher anvils 46 contact with the legs L of the leading staple S which has been pushed to the delivery end of the tool 2 by the pusher 14 of the magazine 10. At this stage, the legs L of the staple are being pushed into the workpiece W. In FIG. 4, the mount 22 is in a bottom position while the clincher anvils 46 are closed and fully pivoted toward each other, bending the legs L of the leading staple S toward each other. The clincher anvils 46 are also forced into the workpiece to press the legs L of the leading staple S toward each other. By the end of the drive stroke of the mount 22, the legs of the driven staple are clinched on the clincher anvils 46, as illustrated in FIG. 4.

The body of the clincher arms 44 can be metallic and formed from steel, for example. Alternatively, the body of the clincher arms can be titanium or other rigid metal. Other materials that can be used to form the clincher arms include a rigid resin material, plastic or a composite material. Further, a combination of materials or material properties can be used for the clincher arms.

The motor 26 drives the transmission or gear reduction mechanism 28, which in turn can actuate and advance the mount 22 to cause the driver 23 to strike the crown C of the leading staple S shown in FIGS. 2-4.

For the purpose of effecting the movement of the mount 22 through successive operative cycles of movement, the battery pack 18 supplies energy to an electric motor. The motor 26, can be carried by the housing 4 or the motor-transmission unit 12 in a position parallel to the handle 6 and rearwardly of the housing section 4. The gear reduction mechanism 28, which may be a planetary gear reduction mechanism, is also carried by the housing 4 or motor-transmission unit 12. The gear reduction mechanism 28 is rotatably connected to the motor 26 through the motor output shaft 30 so that the rotation of the motor output shaft 30 rotates the gear reduction mechanism 28. The gear reduction mechanism 28 transmits a rotational force to the crankshaft 32. The crankshaft 32 is rotatably connected to the crank arm 34. The rotational energy of the motor 26 is transmitted through the gear reduction mechanism 28 to the crankshaft 32 to reduce the speed of rotation and increase the torque applied to the crank arm 34. The crank arm 34 rotates along a circular path about the crankshaft 32. When the trigger member 52 is actuated and the safety is engaged, a connection is made between the battery 18 and a microprocessor unit. If the voltage of the battery 18 is within predetermined operating limits (in terms of voltage, current and temperature) the microprocessor applies a voltage to the motor 26, which begins the actuation sequence. The motor 26 will rotate the crankshaft 32, which in turn simultaneously advances the mount 22 and extends the clincher arms 44 driving the staple into the carton or workpiece W. The motor 26 will then continue to turn, returning both the driver 23 and clincher arms 44 until the mount 22 is sensed by a proximity sensor signaling to the microprocessor that the cycle has concluded. At this point, the microprocessor sends a braking signal to the motor 26 and waits for the user to release and re-engage the trigger 52 prior to another cycle commencing. As a result, the torque is applied to the crank arm 34.

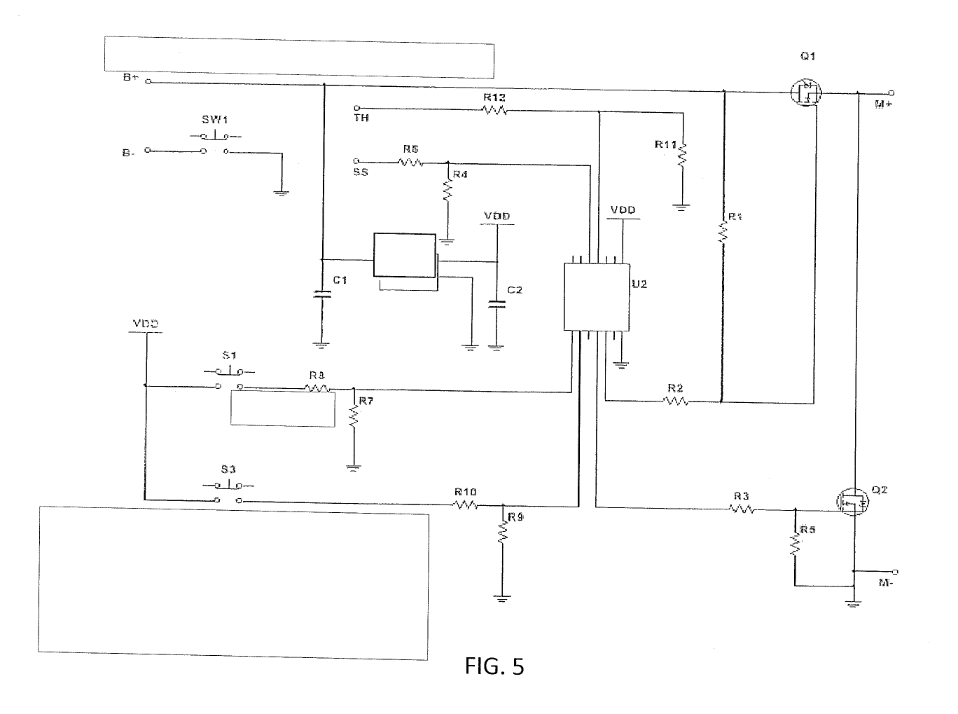

An aspect of the invention is discussed herein with reference to FIG. 5 and continued reference to FIGS. 1-4. Since the driver mounting block 22 and the connecting rod 36 are mechanically connected to the motor 26 via the crankshaft 32 and crank arm 34, continued rotation of the motor 25 between successive operating cycles causes the driver mounting block 22 to continue its upward and downward strokes, even if the user does not press the trigger 52. This may cause the tool to become inadvertently locked in the workpiece W. One way to avoid this is to mechanically disengage the crankshaft 32 or other mechanical components from the motor 26 using, for example, a clutch system. Such systems tend to be expensive and difficult to design and implement. Also, even if the crankshaft 32 is disengaged from the motor 26, continued rotation of the motor 26 unnecessarily consumed too much power during the operating cycles.

In an aspect of the invention, in order to prevent the driver mounting block 22 and other components from moving between the operating cycles, an automatic motor braking mechanism is provided. Conventional braking mechanisms in power tools typically involve braking the motor by shorting the motor field windings when a user turns off the tool or releases the trigger switch. According to an embodiment of the invention, the braking mechanism in the fastener driving tool 2 is executed automatically via controller 66 coupled to a sensor 62 arranged to detect an almost uppermost position of the mechanical components of the fastener driving tool 2. According to embodiment, the sensor 62 is provided to monitor the position of the connecting rod 36 and/or the driver mounting block 22. The sensor 62 may be a Hall Effect sensor arranged to sense a sense magnet (not shown) positioned within the connecting rod 36 or the driver mounting block 22. The sensor 62 in this case senses the magnetic flux above a certain threshold generated by the sense magnet. Accordingly, once the sense magnet reaches a predetermined position, which may be indicative of the uppermost position of the connecting rod 36 and the driver mounting block 22, the Hall Effect sensor 62 issues a position signal to controller 66 located on a circuit board 64, as will be described below in detail.

It is noted that the Hall Effect sensor 62 is one example of a contactless sensor, although other types of contact or contactless position and/or proximity sensors may also be utilized. For example, sensor 62 may be a proximity sensor arranged to sense when the connecting rod 36 or the driver mounting block 22 reaches a predetermined position. Alternatively, sensor 62 may be a single-pole-single-throw switch that is mechanically actuated by the top of the rod 36 or the driver mounting block 22 when they reach their uppermost position. In yet another embodiment, sensor 62 may be an inductor that yields a variable voltage based on the position of the sense magnet.

It is further noted that while the sensor 62 is commonly positioned to monitor the position of the connecting rod 36 or the driver mounting block 22, sensor 62 may be alternatively positioned to sense longitudinal upward movement of other mechanical components such as upper pivot pin 37 or linkage 42. If sensor 62 is a Hall Effect sensor, the sense magnet may in that case be placed within or in contact with one of these components. Furthermore, sensor 62 may be positioned to sense radial position of the crank arm 34 or the pivot point 35 and issue the position signal when these components reach a predetermined rotationally position, e.g., after 355 degrees of a cycle.

Referring now to FIG. 5, an exemplary circuit diagram to facilitate the braking mechanism is herein discussed, according to an embodiment. The circuit diagram illustrated hereby may be implemented on the circuit board 64 of FIG. 1. The position signal of the sensor 62 (discussed above) is coupled to a position switch S3. Switch S1 is coupled to the actuation member 52 shown in FIG. 1. Both switches S1 and S3 are on the path of the Vdd power to the control unit U2. The Vdd power input to switches S1 and S3 is obtained from the B+ and B− battery terminals through the voltage regulator U1 and capacitors C1 and C2. In an exemplary embodiment, this arrangement produces a Vdd voltage of 5V from the battery power source, which may be anywhere from 8 to 30 V or more.

In addition to switches S1 and S3, the circuit diagram includes a switch SW1, which is a safety switch coupled to the safety trigger switch 60 shown in FIG. 1. Switch SW1 ensures that the tool will not operate unless the safety trigger switch 60 is actuated by the user. Specifically, the safety trigger switch 60 is arranged on the tool handle 6 as a precautionary measure in addition to the trigger switch 52 and is engageable by the palm of the user's hand when the user intends to operate the tool 2. Safety switch SW1 cuts off power from the battery terminal B− to the rest of the circuit when the safety trigger switch 60 is not engaged by the user.

Control unit U2, which corresponds to controller 66 shown in FIG. 1, may be any processing unit such as a microprocessor or a microcontroller. In an embodiment, control unit U2 controls the various operations of the tool 2 and the motor 26. In an embodiment, the control unit U2 may take various operating conditions into account. For example, in addition to S1 and S3 switches, the control unit U2 may receive inputs from nodes SS and TH. Node SS in this embodiment is coupled to a cell in the battery pack 18 cell stack to indicate the state of charge of the battery pack 18. If the battery pack 18 is in an under-voltage condition, i.e., the charge of the battery pack is too low, node SS indicates to the control unit U2 to, for example, shut off the tool. Node TH is coupled to a thermister in the battery pack 18 and indicates to the control unit U2 whether the battery pack 18 is within an acceptable operational temperature range.

Control unit U2 uses the inputs from switches S1 and S3 and nodes SS and TH to determine whether to supply battery power to the motor 26. Specifically, control unit U2 controls a transistor switch Q1 arranged on the path of current from battery node B+ to supply battery power to the M+ motor terminal. Each time the trigger switch 52 is actuated by the user, control unit U2 provides battery power to run the motor 26.

According to an embodiment, in order to brake the motor after the completion of a cycle, sensor 62 issues a position signal when the connecting rod 36 and/or driver mounting block 22 reaches a predetermine (i.e., substantially uppermost) position. When sensor 62 issues the position signal via switch S3 to the control unit U2, control unit U2 interrupts battery power to the motor via transistor switch Q1 and brakes the motor 26 via a second transistor switch Q2 arranged between the two motor terminals M+ and M−. Control unit U2 may activate switch Q2 immediately or after a predetermined delay after transistor switch Q1 is closed. By shorting the motor terminals M+ and M−, the switch Q2 allows for the back EMF (Electro-Magnetic Field) of the motor 26 to flow in the opposite direction of the motor rotation, which stops motor 26 from freewheeling.

According to an embodiment, it takes approximately 15 milliseconds to brake the motor, which is sufficient time for the connecting rod 36 to stop before (or at initial stages of) its downward movement. Accordingly, after a staple has been embedded into the workpiece W, the motor continues to rotate until the connecting rod 36 and the associated mechanical components return to their uppermost position, thereby concluding the cycle. The control unit U2 waits until the user releases and re-engages the trigger switch 52 prior to commencing another cycle.

In the embodiment describe above a sensor 62 issues a logic position signal to the control unit U2 indicative of the uppermost position of one of the mechanical components such as the connecting rod 36 or the driver mounting block 22, and the control unit U2 brakes the motor in accordance with the logic position signal. It is envisioned, however, that some sensing mechanisms may be used to provide a variable analog signal to the control unit U2. For example, sensor 62 may be an inductor that yields a variable voltage based on the position of the sense magnet. In that case, the control unit U2 will be configured to monitor the variable voltage provided by the inductor and brake the motor when the variable voltage reaches a predetermined threshold.

It must be noted that while the above description is in reference to a fastener driving tool, the braking mechanism disclosed herein may be used with any other tool that involves axial movement of a mechanical components via a rotating motor. For example, the braking mechanism describes herein may be used with an electric nailer. Also, while the control unit in this embodiment is configured to brake the motor during every upward stroke after a staple has been fired into the workpiece W, the control unit may alternatively be configured to allow for

It will be appreciated that the above description is merely exemplary in nature and is not intended to limit the present disclosure, its application or uses. While specific examples have been described in the specification and illustrated in the drawings, it will be understood by those of ordinary skill in the art that various changes may be made and equivalents may be substituted for elements thereof without departing from the scope of the present disclosure as defined in the claims. Furthermore, the mixing and matching of features, elements and/or functions between various examples is expressly contemplated herein, even if not specifically shown or described, so that one of ordinary skill in the art would appreciate from this disclosure that features, elements and/or functions of one example may be incorporated into another example as appropriate, unless described otherwise, above. Moreover, many modifications may be made to adapt a particular situation or material to the teachings of the present disclosure without departing from the essential scope thereof. Therefore, it is intended that the present disclosure not be limited to the particular examples illustrated by the drawings and described in the specification as the best mode presently contemplated for carrying out the teachings of the present disclosure, but that the scope of the present disclosure will include any embodiments falling within the foregoing description and the appended claims.

1. A power tool comprising:
a housing;
a driver configured to move downward during a drive stroke and upward during a return stroke;
an electric motor configured to drive the driver; and
a control unit configured to control a supply of power form a power source to the motor and brake the motor upon or within a predetermined time after the driver reaches approximately its uppermost upward position to stop the motor prior to the completion of the return stroke.

2. The power tool of claim 1, wherein the driver is configured to drive a fastener into a workpiece during the drive stroke.

3. The power tool of claim 1, further comprising a sensor arranged to detect a position of a moving component associated with the driver.

4. The power tool of claim 3, wherein the sensor is a Hall Effect sensor, further comprising a sense magnet provided inside or in association with the moving component, the sense magnet being sensable by the Hall Effect sensor when the moving component reaches a predetermined position.

5. The power tool of claim 3, wherein the sensor is a switch that is mechanically actuated when the moving component reaches a predetermined position.

6. The power tool of claim 3, wherein the sensor is configured to provide a position signal to the control unit when the moving component reaches a predetermined position, and the control unit is configured to brake the motor upon receiving the position signal from the sensor.

7. The power tool of claim 3, wherein the sensor provides a variable voltage to the control unit indicative of the position the moving component and the control unit is configured to brake the motor when the variable voltage exceeds a predetermined threshold.

8. The power tool of claim 3, further comprising:
a crank arm connected to the motor; and
a connecting rod pivotably coupled to the driver at one end portion thereof and pivotably connected to the crank arm at an opposite end portion thereof, the connecting rod being configured to pull the driver downward through the drive stroke when the crank arm rotates with the motor.

9. The power tool of claim 8, wherein the moving component comprises one of the connecting rod or the driver, and the sensor is arranged to detect a predetermined axial position of the moving component.

10. The power tool of claim 8, wherein the moving component comprises the crank arm, and the sensor is arranged to detect a predetermined angular position of the moving component.

11. The power tool of claim 8, wherein the moving component comprises a mount connecting the driver to the connecting rod, and the sensor is arranged to detect a predetermined axial position of the moving component.

12. The power tool of claim 1, wherein the motor comprises a positive terminal and a negative terminal, and the control unit is configured to brake the motor by activating a switch to short the positive and negative terminals of the motor.

13. The power tool of claim 1, wherein the control unit is configured to stop supply power to the motor at a predetermined time before it brakes the motor.

14. The power tool of claim 1, further comprising an input switch actuated by a user, wherein the control unit is configured to supply power to drive the motor when the input switch is actuated by the user.
